(19) United States
(12) Patent Application Publication
(10) Pub. No.: US 2016/0189126 A1
(43) Pub. Date: Jun. 30, 2016

(54) METHOD AND SYSTEM FOR SAFELY TRANSMITTING TRANSACTION SENSITIVE DATA BASED ON CLOUD POS

(71) Applicant: CHINA UNIONPAY CO., LTD., Shanghai (CN)

(72) Inventors: Zhiqiang Cheng, Shanghai (CN); Zhou He, Shanghai (CN); Qi Wang, Shanghai (CN); Shou He, Shanghai (CN)

(73) Assignee: CHINA UNIONPAY CO., LTD., Shanghai (CN)

(21) Appl. No.: 14/907,036

(22) PCT Filed: Jul. 25, 2014
(86) PCT No.: PCT/CN2014/083003

§ 371 Date: Jan. 22, 2016

(30) Foreign Application Priority Data
Jul. 31, 2013 (CN) 201310326834.7

(51) Int. Cl. G06Q 20/20; G06Q 20/40

(52) U.S. Cl. CPC G06Q 20/206; G06Q 20/401; G06Q 2220/00

(57) ABSTRACT

The present application discloses a secure transfer method for cloud-based POS transaction sensitive data, comprising steps of: (a) exchanging a transaction process key with the cloud POS terminal; (b) receiving, from the cloud POS terminal, the transaction request packet encrypted by using the transaction process key; and (c) obtaining the transaction sensitive data from the transaction request packet, and using the transaction process key to operate on the transaction sensitive data so as to upload to the financial acquiring platform. The present invention also discloses a secure transfer system for cloud-based POS transaction sensitive data.

### TECHNICAL FIELD

The present invention relates to the field of financial data processing, and particularly, to a secure transfer method and system for a cloud-based POS transaction sensitive data.

### BACKGROUND ART

A Pont Of Sale (POS) terminal is a settlement terminal that may enable a bankcard consumption by a cardholding consumer and has been widely used in various consuming situations such as shopping malls, efficiently meeting the consumer's demand for the bankcard consumption and improving the consumer's consumption experience.

The POS terminal is to implement a bankcard consumption by primarily reading the account information of the card held by the consumer and sending it, together with the amount of consumption and the merchant's information, to the financial acquiring platform, which then implements the charging of the consumer, wherein the POS terminal is an apparatus certificated by the financial acquiring platform, has an unique identification representative of the merchant information, and is an apparatus representative of the terminal holder. The POS terminal is required to be registered on the financial acquiring platform before it is brought into use. After the financial platform has received the consumption information sent by the POS terminal, it first identity the identification of the POS terminal, and charges the consumer. The process for charging the consumer is one for transferring the amount of consumption of the consumer from the account of the consumer to the account of the merchant.

Existing POS terminals would typically communicate with financial acquiring platform(s) directly. As they employ backward technical architectures, problems such as too high POS operation and maintenance cost, difficulty of promoting new services for terminals, and the like often arise. In addition, as for existing POS terminals, most of them employ dial-in approaches, wherein the security of the transaction data is completely dependent on private network channels; while others of them employ Internet access approaches, wherein the security of the transaction data is completely dependent on secure network channels such as 3G. That is, the transaction data itself is not guaranteed by additional secure measures.

### SUMMARY OF THE INVENTION

To address the foregoing problem(s), the inventor of the present invention proposes an Internet secure access approach of employing cloud POS that while guaranteeing the security of the access channel, employs the secure encryption of the financial transaction data to better improve the transaction security for financial POS and facilitate the development of POS industry.

According to an aspect of the present invention, there is provided a secure transfer method for cloud-based POS transaction sensitive data, comprising steps of: (a) exchanging a transaction process key with the cloud POS terminal; (b) receiving, from the cloud POS terminal, the transaction request packet encrypted by using the transaction process key; and (c) obtaining the transaction sensitive data from the transaction request packet, and using the transaction process key to operate on the transaction sensitive data so as to upload to the financial acquiring platform.

In the above-mentioned secure transfer method, the step (a) comprises steps of receiving a sign-in request from the payment application in the cloud POS terminal; based on the sign-in request, emanating the transaction process key through the transaction primary key; generating a sign-in packet, which contains the transaction process key; and sending the packet down to the cloud POS terminal through the secure channel.

In the above-mentioned secure transfer method, the transaction primary key corresponds to the cloud POS terminal, and is injected into the secure module of the cloud POS terminal during the initialization of the cloud POS terminal.

In the above-mentioned secure transfer method, the step (c) comprises steps of parsing the transaction request packet to obtain the transaction sensitive data; using the transaction process key to decrypt and validate the integrity of the data; and uploading the transaction sensitive data to the financial acquiring platform in an appropriate packet format.

According to another aspect of the present invention, there is provided a secure transfer method for a cloud POS transaction sensitive data, comprising steps of: (a) exchanging a transaction process key with a cloud POS background system; (b) obtaining a transaction sensitive data, and using the transaction process key to symmetrically encrypt the transaction sensitive data; and (c) sending, through the secure channel, a transaction request packet to the cloud POS background which processes the packet and sends it to the financial acquiring platform, wherein the transaction request packet contains the encrypted transaction sensitive data.

In the above-mentioned transfer method, the step (a) comprises steps of initiating a sign-in request to the cloud POS background system; receiving the sign-in response packet from the cloud POS background system, the sign-in response packet containing the transaction process key emanated by the transaction encryption module in the cloud POS background system through the transaction primary key; and storing the transaction process key.

In the above-mentioned secure transfer method, the transaction primary key corresponds to the cloud POS terminal, and is injected into the secure module of the cloud POS terminal during the initialization of the cloud POS terminal.

According to another aspect of the present invention, there is provided a secure transfer system for a cloud-based POS transaction sensitive data, comprising a cloud POS system that contains a transaction encryption/decryption module for managing the transaction process key and performing the encryption/decryption operation on the transaction sensitive data; and a cloud POS terminal that contains a secure module for saving at least a transaction process key and a transaction primary key for the terminal; wherein before the user of the cloud POS terminal carries out the financial transaction, the cloud POS background system and the cloud POS terminal exchange the transaction process key; the payment application running on the cloud POS terminal accesses the encrypted interface of the secure module, the secure module symmetrically encrypts the transaction sensitive data through the transaction process key, and returns the encrypted ciphertext to the payment application; the payment application sends a transaction request packet to the cloud POS background through a secure channel; the cloud POS background parses the transaction request packet to obtain the transaction sensitive data, and then uses the transaction process key to decrypt; the cloud POS background uploads the transaction sensitive data to the cloud POS background in an appropriate packet format.

In the above-mentioned secure transfer system, the cloud POS terminal is configured to exchange the transaction process key with the cloud POS background system in a manner such that the payment application running on the cloud POS terminal initiates a sign-in request to the cloud POS background system; after the cloud POS background has received the sign-in request, the transaction encryption/decryption module therein emanates the transaction process key through the transaction primary key, and then generates a response packet, and sends it down to the cloud POS terminal through the secure channel; and after the cloud POS terminal has received the sign-in response packet, the payment application accesses the secure module to save the transaction process key in the secure module, wherein the transaction process key is protected by the transaction primary key.

### BRIEF DESCRIPTION OF DRAWINGS

Various aspects of the present invention will be readily apparent to those of ordinary skill in the art when embodiments of the present invention are read with reference to the accompanying drawings. It should be understood by those of ordinary skill in the art that these accompanying drawing are used only to illustrate technical solutions of the present invention in conjunction with embodiments, and are not intended to limit the claimed scope of the present invention.

FIG. 1 is a schematic diagram of a secure transfer system for a cloud-based POS transaction sensitive data in accordance with one embodiment of the present invention.

### DETAILED DESCRIPTION OF EMBODIMENTS

What is introduced below is some of possible embodiments of the present invention, aiming to provide a basic understanding of the present invention and not to identify the key or deterministic element or define the claimed scope. It is readily appreciated that other implementations that may be replaced with each other may be advised by those of ordinary skill in the art according to technical solutions of the present invention, without altering the essential spirit of the present invention. Therefore, the following embodiments and accompanying drawings are only illustrative of technical solutions of the present invention, and should not be regarded as the entirety of the present invention or as definition or limitation of technical solutions of the present invention.

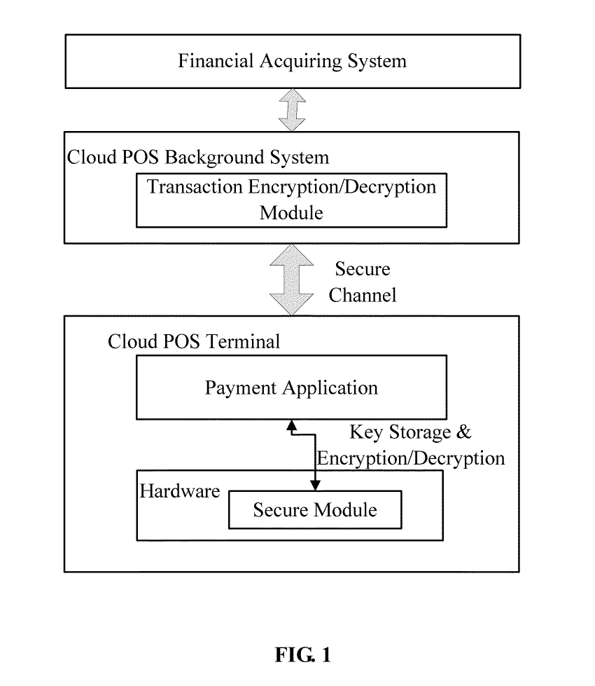

Referring to FIG. 1, it shows a schematic diagram of a secure transfer system for a cloud-based POS transaction sensitive data in accordance with one embodiment of the present invention.

As shown in FIG. 1, a secure module is part of a cloud POS terminal hardware that includes, but is not limited to, a password keyboard, a cloud POS secure storage module (which is located on a terminal hardware motherboard or embedded in a CPU) and the like. The secure module can save at least a transaction primary key and a transaction process key, and can perform an encryption/decryption operation.

The payment application runs on the cloud POS terminal system, main functions of which include: (1) a secure storage of the transaction process key (before carrying out the financial transaction operation with the cloud POS background, it has to first negotiate the transaction process key with the background, and then securely store the transaction progress key in the secure module (the transaction process key is protected by the transaction primary key)); and (2) transaction data encryption/decryption (obtain and display user input/output data (a card number, a CVN number, a transaction amount, etc.)). After obtaining the user transaction data, the payment application symmetrically encrypts the transaction data through the secure module (the encryption algorithm is not limited to DES, 3DES and the like), and then uploads the transaction data to the cloud POS background system through the secure channel.

The transaction encryption/decryption module is one of important parts of the cloud POS background system, main functions of which includes: (1) management of transaction process key (before carrying out the financial transaction, the transaction process key is emanated through the transaction primary key, then is sent down to the cloud POS terminal, and is securely stored by the payment application for encryption/decryption of the transaction data); (2) decryption of the transaction sensitive data uploaded by the payment application, output of the transaction sensitive data plaintext thereafter, and upload of the transaction sensitive data plaintext to the financial acquiring platform in some packet format.

According to one embodiment of the present invention, a secure transfer method for a cloud-based POS transaction sensitive data is performed by the system as shown in FIG. 1. Specifically, the transaction process key management flow may be illustrated as follows:

Firstly, when the cloud POS terminal is deployed, parameter initialization of the cloud POS terminal is performed manually. The transaction primary key (there are a record in the cloud POS background system) corresponding to this piece of terminal is injected into the secure module of the cloud POS terminal.

Secondly, the cloud POS terminal user (cashier) first carries out the transaction process key negotiation operation (sign-in operation) before the financial transaction (transactions such as consumption, pre-authorization, etc.) is carried out.

Thirdly, the whole sign-in flow is as follows: (1) the payment application initiates the sign-in request to the cloud POS background system (hereinafter “background”) through the secure channel; (2) after the background has received the request, the transaction encryption/decryption module therein emanates the transaction process key through the transaction primary key, then generates the sign-in response packet, and sends it down to the cloud POS terminal through the secure channel; and (3) after the cloud POS terminal has received the response packet, the payment application accesses the secure module, and securely saves the transaction process key in the secure module (the transaction process key is protected by the transaction primary key).

Fourthly, the flow ends.

The secure transfer flow of the transaction sensitive data is as follows:

Firstly, the cloud POS terminal user (cashier) carries out the financial transaction (transactions such as consumption, pre-authorization, etc.), and the payment application obtains the transaction data (the card number, the CVN number, the transaction amount, etc.).

Secondly, the payment application accesses the encrypted interface of the secure module, which then symmetrically encrypts the transaction sensitive data (the card number, the CNV number, the transaction amount, etc.) through the transaction process key being sign-in negotiated, and returns the encrypted ciphertext to the payment application.

Thirdly, the payment application sends the transaction request packet to the background through the secure channel.

Fourthly, the background parses the transaction request packet, obtains the transaction sensitive data, then uses the transaction process key to decrypt and perform data integrity validation and the like, and finally uploads it to the financial acquiring platform in some packet format.

Fifthly, the flow ends.

To summarize the above, the present invention is to propose a novel secure transfer solution for cloud POS transaction data that uses a dynamical process key encryption approach, and encrypts the transaction sensitive data while guaranteeing the security of the transaction access channel, improving the security of the transaction data. The solution has the following advantages:

1. Supplement of the transaction security for a traditional terminal, which is advantageous for the promotion and development of the cloud POS terminal, facilitating the development of financial POS industry.

2. In the solution, a traditional financial acquiring platform is not required to be modified, and is simple to be implemented with good compatibility.

The embodiments of the present invention are described above with reference to accompanying drawings. However, those of ordinary skill in the art can be appreciated that various alterations and substitutions may be made to the embodiments of the present invention without departing from the spirit and scope of the present invention. These alterations and substitutions will fall within the scope of the present invention as defined by the appended claims.

1. A secure transfer method for a cloud-based POS transaction sensitive data, comprising steps of:
(a) exchanging a transaction process key with a POS terminal;
(b) receiving, from the cloud POS terminal, a transaction request packet encrypted by using the transaction process key; and
(c) obtaining a transaction sensitive data from the transaction request packet, and performing operations on the transaction sensitive data by using the transaction process key in order to upload to a financial acquiring platform.

2. The secure transfer method according to claim 1, wherein the step (a) comprises:
receiving a sign-in request from a payment application in the cloud POS terminal;
based on the sign-in request, emanating the transaction process key through a transaction primary key;
generating a sign-in packet, the packet containing the transaction process key; and
sending the packet down to the cloud POS terminal through a secure channel.

3. The secure transfer method according to claim 2, wherein the transaction primary key corresponds to the cloud POS terminal, and is injected into the secure module of the cloud POS terminal during the initialization of the cloud POS terminal.

4. The secure transfer method according to claim 1, wherein the step (c) comprises:
parsing the transaction request packet to obtain the transaction sensitive data;
using the transaction process key to decrypt and perform data integrity validation; and
uploading the transaction sensitive data to the financial acquiring platform in an appropriate packet format.

5. A secure transfer method for a cloud-based POS transaction sensitive data, comprising steps of:
(a) exchanging a transaction process key with a cloud POS background system;
(b) obtaining the transaction sensitive data, and using the transaction process key to symmetrically encrypt the transaction sensitive data; and
(c) sending, through the secure channel, the transaction request packet to the cloud POS background, which processes the packet and then uploads it to the financial acquiring platform, wherein the transaction request packet contains the encrypted transaction sensitive data.

6. The secure transfer method according to claim 5, wherein the step (a) comprises:
initiating the sign-in request to the cloud POS background system through the secure channel;
receiving the sign-in response packet from the cloud POS background system, the sign-in response packet containing the transaction process key emanated by the transaction encryption/decryption module in the cloud POS background system through the transaction primary key; and
storing the transaction process key.

7. The secure transfer method according to claim 6, wherein the transaction primary key corresponds to the cloud POS terminal, and is injected into the secure module of the cloud POS terminal during the initialization of the cloud POS terminal.

8. A secure transfer system for a cloud-based POS transaction sensitive data, comprising:
a cloud POS background system, which contains the transaction encryption/decryption module for managing the transaction process key and for performing the encryption/decryption operation on the transaction sensitive data; and
a cloud POS terminal, which contains the secure module for at least saving the transaction process key and the primary key for the terminal;
wherein before the POS terminal user carries out the financial transaction, the cloud POS background system exchanges the transaction process key with the cloud POS terminal; the payment application running on the cloud POS terminal accesses the encrypted interface of the secure module, the secure module symmetrically encrypts the transaction sensitive data through the transaction process key, and returns the encrypted ciphertext to the payment application; the payment application sends the transaction request packet to the cloud POS background through the secure channel; the cloud POS background parses the transaction request packet, obtains the transaction sensitive data, and then uses the transaction process key to decrypt; the cloud POS background uploads the transaction sensitive data to the financial acquiring platform in an appropriate packet format.

9. The secure transfer system according to claim 8, wherein the cloud POS terminal is configured to exchange the transaction process key with the cloud POS background system in the following manner:
the payment application running on the cloud POS terminal initiates the sign-in request to the cloud POS background system through the secure channel;
after the cloud POS background has received the sign-in request, the transaction encryption/decryption module therein emanates the transaction process key through the transaction primary key, then generates the sign-in response packet, and sends it down to the cloud POS terminal through the secure channel; and
after the cloud POS terminal has received the sign-in response packet, the payment application accesses the secure module to save the transaction process key in the secure module, wherein the transaction process key is protected by the transaction primary key.
